(19) United States
(12) Patent Application Publication
(10) Pub. No.: US 2002/0187802 A1
(43) Pub. Date: Dec. 12, 2002

(54) Method of adjusting the target value of an inner power control loop in a mobile radiocommunications system

(75) Inventors: Pascal Agin, Sucy En Brie (FR); Nicolas Billy, Palaiseau (FR)

Correspondence Address: SUGHRUE, MION, ZINN,, MACPEAK & SEAS, PLLC, Suite 800, 2100 Pennsylvania Avenue, N.W., Washington, DC, 20037-3213, US

(73) Assignee: ALCATEL

(21) Appl. No.: 10/166,066

(22) Filed: Jun. 11, 2002

(30) Foreign Application Priority Data
Jun. 12, 2001 (FR) 01 07 690

(51) Int. Cl. H04B 7/00

(52) U.S. Cl. 455/522; 455/69

(57) ABSTRACT

In one aspect, the present invention provides a method of adjusting the target value of an inner power control loop in a mobile radiocommunications system, in which method:

said inner loop target value is adjusted by a control loop referred to as a “first outer loop” operating on the basis of a quality indicator referred to as a “first quality indicator” and of a target value for said first quality indicator referred to as a “first outer loop target value”;

said first outer loop target value is adjusted by a control loop referred to as a “second outer loop” operating on the basis of a quality indicator referred to as a “second quality indicator” and of a target value for said second quality indicator referred to as a “second outer loop target value”; and

said second quality indicator gives an error rate and said first outer loop target value is adjusted each time an error is detected.

The present invention relates in general to mobile radiocommunications systems, and in particular to so-called “code division multiple access” (CDMA) systems.

The present invention is specifically applicable to so-called “third generation” system such as the universal mobile telecommunication system (UMTS).

### BACKGROUND OF THE INVENTION

In general, in such systems, one of the objectives is to increase performance, i.e. specifically to increase capacity and/or improve quality of service.

One technique in common use is the “power control” technique, and in particular the closed loop power control technique.

The purpose of closed loop power control is to ensure that on each link between a base station and a mobile station, a parameter representative of transmission quality over the link is maintained as close as possible to a target value, where said parameter may be constituted, for example, by the signal-to-interference ratio (SIR). By way of example, in the up direction (i.e. from the mobile station to the base station), the base station periodically estimates SIR and compares the estimated SIR with a target SIR value. If the estimated SIR is less than the target SIR, then the base station instructs the mobile station to increase the power at which it is transmitting. In contrast, if the estimated SIR is greater than the target SIR, then the base station instructs the mobile station to decrease the power at which it is transmitting.

The target SIR value is an important parameter in such systems. If the target SIR is set at a value that is higher than the value that is necessary, then the level of interference within the system is increased pointlessly, thereby degrading the performance of the system pointlessly. Conversely, if the target SIR is fixed at a value that is lower than the value necessary, then quality of service is degraded over the link in question.

The target SIR value is generally selected as a function of the required quality of service, and it is commonly adjusted by an “outer” loop algorithm (as contrasted with the preceding algorithm which is also referred to as an “inner” loop algorithm). The principle of the outer loop algorithm is generally to estimate the quality of service on a regular basis and to compare the estimated quality of service with a required quality of service or with a target quality of service. If the estimated quality of service is lower than the required quality of service, the target SIR is increased, otherwise the target SIR is reduced. Unlike the inner loop algorithm which needs to be fast in order to track possible variations in SIR as closely as possible, the outer loop algorithm is usually slower since quality needs to be averaged over a certain period of time in order to obtain a reliable estimate.

It is also recalled that such systems generally make use of techniques for providing protection against transmission errors, which techniques are also referred to as channel coding (on transmission) or channel decoding (on reception). Channel coding includes processing such as, in particular, error detection and/or correction coding and interlacing, such processing generally being applied to sequences of bits also known as frames or blocks, as appropriate, for example.

Quality of service is generally represented by an error rate estimated on reception after channel decoding. Thus, use is generally made of quality of service indicators such as: bit error rate (BER); frame erasure rate (FER); block erasure rate (BLER), etc.

A raw error rate (raw BER) is also defined as the error rate prior to channel decoding, as obtained by comparing the received data prior to error correction decoding with the corresponding data as obtained after error correction decoding and then re-coded using the same error correcting code as for transmission.

The outer loop algorithm that is generally used is the “sawtooth” algorithm. An example of such an algorithm is as follows:

when a block is detected as erroneous on reception, the target SIR is increased by δᵤₚ decibels (dB); and

when a block is detected as being not erroneous on reception, the target SIR is decreased by δ_{down} dB.

Where δᵤₚ and δ_{down} are two parameters of the algorithm that satisfy:

δᵤₚ*BLER_{target}=δ_{down}*(1−BLER_{target})

so that average BLER is equal to target BLER (i.e. BLER_{target}).

The performance obtained with such an algorithm is relatively good for a target BLER of about 10⁻² or a little less. However the performance is rather bad for target BLER of much lower value (10⁻³ or less) Unfortunately, with certain services, e.g. such as circuit mode data services, the required quality of service generally corresponds to a BER of about 10⁻⁶ which usually corresponds to a target BLER lying in the range 10⁻⁵ to 10⁻⁴. This rather poor performance is due essentially to the fact that such an algorithm is based on estimating BLER, which means that it is not possible to obtain an quality indicator that is sufficiently precise and reactive. In a system such as the UMTS, for example, the number of blocks per transmission time interval (TTI) is relatively low, typically one block per TTI, where TTI can take on values that are relatively high such as 20 milliseconds (ms), 40 ms, or 80 ms depending on the type of service (for more information about these aspects of UMTS, reference can be made for example to specification 3G TS 25.212 as published in 3rd Generation Partnership Project (3GPP)).

Other examples of outer loop algorithms have been proposed in order to avoid the drawbacks of the “sawtooth” algorithm.

In document WO 99/05808, the outer loop is made up of two loops:

a first loop which adjusts the target value for the second loop as a function of the difference between a first quality indicator (specifically FER) and a target value for said first quality indicator; and

a second loop which adjusts the target value of the inner loop as a function of the difference between a second quality indicator (specifically symbol error rate (SER)) and the target value determined by the first loop, with such adjustment being performed only if the difference exceeds a given threshold.

Document DE 199 30 747 likewise relates to an outer loop made up of two loops: a first loop which adjusts the target SIR value as a function of an quality indicator such as raw BER, and a second loop which adjusts a target value for said quality indicator as a function of an error rate.

In document WO 01/01600, the outer loop is made up of two loops, each performing adjustment on the target value for the inner loop:

a first loop which proceeds with relatively large adjustments of the target value for the inner loop when a frame is detected as being bad or when a certain number of consecutive frames are detected as being good; and

a second loop which, in the absence of any adjustment by the first loop, performs smaller adjustments to keep an error rate known as transmission channel error rate on a target value (which error rate is obtained by comparing the signal obtained after decoding with a signal obtained by re-coding the decoded signal). Furthermore, when the first loop decides that it is necessary to adjust the target value of the inner loop, then the transmission channel error rate which is then obtained is assumed to be a value that is acceptable for the target value to be achieved by the second loop.

### OBJECTS AND SUMMARY OF THE INVENTION

A particular object of the present invention is likewise to avoid the drawbacks of the “sawtooth” algorithm, but while further optimizing performance.

In one aspect, the present invention provides a method of adjusting the target value of an inner power control loop in a mobile radiocommunications system, in which method:

said inner loop target value is adjusted by a control loop referred to as a “first outer loop” operating on the basis of a quality indicator referred to as a “first quality indicator” and of a target value for said first quality indicator referred to as a “first outer loop target value”;

said first outer loop target value is adjusted by a control loop referred to as a “second outer loop” operating on the basis of a quality indicator referred to as a “second quality indicator” and of a target value for said second quality indicator referred to as a “second outer loop target value”; and

said second quality indicator gives an error rate and said first outer loop target value is adjusted each time an error is detected.

According to another characteristic, the information transmitted in said system is structured in blocks on the basis of which said second quality indicator is obtained, and said first outer loop target value is adjusted block by block.

According to another characteristic, the second outer loop adjusts the first outer loop target value by a first value or a second value depending on whether or not an error is detected.

According to another characteristic, said first and second values and the second outer loop target value are related in such a manner that on average the second quality indicator reaches the second outer loop target value.

According to another characteristic, said first quality indicator is a transmission quality indicator.

According to another characteristic, said first quality indicator is raw BER.

According to another characteristic, said second quality indicator is a service quality indicator.

According to another characteristic, said second quality indicator is BLER.

In another aspect, the present invention provides a method of adjusting the target value of an inner power control loop in a mobile radiocommunications system, in which method:

said inner loop target value is adjusted by a control loop referred to as a “first outer loop” operating on the basis of a quality indicator referred to as a “first quality indicator” and of a target value for said first quality indicator referred to as a “first outer loop target value”;

said first outer loop target value is adjusted by a control loop referred to as a “second outer loop” operating on the basis of a quality indicator referred to as a “second quality indicator” and of a target value for said second quality indicator referred to as a “second outer loop target value”; and

said first outer loop target value is adjusted only once said first outer loop has already converged.

In another aspect, the present invention provides a method of adjusting the target value of an inner power control loop in a mobile radiocommunications system, in which method:

said inner loop target value is adjusted by a control loop referred to as a “first outer loop” operating on the basis of a quality indicator referred to as a “first quality indicator” and of a target value for said first quality indicator referred to as a “first outer loop target value”;

said first outer loop target value is adjusted by a control loop referred to as a “second outer loop” operating on the basis of a quality indicator referred to as a “second quality indicator” and of a target value for said second quality indicator referred to as a “second outer loop target value”; and

initial values for said inner loop target value and said first outer loop target value are determined so as to be capable of being reached approximately simultaneously for transmission at the same power level.

According to another characteristic, said initial value for the first outer loop target value is obtained by measurements performed for a predetermined value of said inner loop target value.

According to another characteristic, said predetermined value for the inner loop target value is selected to be as close as possible to an ideal value.

According to another characteristic, said initial value for the first outer loop target value is selected to be as close as possible to an ideal value, and said first outer loop target value is adjusted only once said first outer loop has already converged.

The present invention also provides:

a mobile station (in particular user equipment (UE) in a system such as UMTS);

network equipment for mobile radiocommunications (in particular a radio network controller (RNC) in a system such as UMTS, or indeed a base station such as a Node B in a system such as UMTS);

a mobile radiocommunications network; and

a mobile radiocommunications system;

each including means for implementing a method in accordance with the invention.

### BRIEF DESCRIPTION OF THE DRAWINGS

Other objects and characteristics of the present invention appear on reading the following description of embodiments, given with reference to the accompanying drawings, in which:

FIG. 1 is a block diagram for illustrating a first example of a method in accordance with the invention;

FIG. 2 is a block diagram for illustrating a second example of a method in accordance with the invention; and

FIG. 3 recalls the general architecture of a mobile radiocommunications system, such as the UMTS in particular.

### MORE DETAILED DESCRIPTION

Consideration is given to an algorithm for adjusting the inner loop target value, in which:

said inner loop target value is adjusted by a control loop referred to as a “first outer loop” operating on the basis of an quality indicator referred to as a “first quality indicator” and a target value for said first quality indicator, referred to as the “first outer loop target value”; and

said first outer loop target value is adjusted by a control loop referred to as a “second outer loop” operating on the basis of an quality indicator referred to as a “second quality indicator” and a target value for said second quality indicator referred to as a “second outer loop target value”.

By way of example, as shown in FIG. 1:

a first outer loop 1 uses a first quality indicator QI1 to fix the target value of the inner loop (SIR_{target}) more precisely, if QI1<QI1_{target} (where QI1_{target} is the target value of the first outer loop), then SIR_{target} is increased by δ1ᵤₚ, else SIR_{target} is decreased by δ1_{down};

a second outer loop 2 uses a second quality indicator QI2 to fix QI1_{target}:

more precisely, if QI2<QI2_{target} (where QI2_{target} is the second outer loop target value), QI1_{target} is increased by δ2ᵤₚ, otherwise QI1_{target} is decreased by δ2_{down}.

QI1 and QI2 are two quality indicators (such as BLER, BER, raw BER, . . . ) which can be estimated in any conventional manner during performance of the algorithm.

For example, BLER can be estimated by detecting erroneous blocks using a cyclic redundancy check (CRC) code since there is generally one CRC per block (particularly in the case of UMTS).

QI1 and QI2 can be the same quality indicator, even though this is not the most advantageous circumstance in practice.

δ1ᵤₚ, δ1_{down}, δ2ᵤₚ and δ2_{down} are parameters of this algorithm. They can be positive or negative with the constraint that δ1ᵤₚ and δ1_{down} (i=1, 2) must have the same sign. It will be observed that the fact of having negative values instead of positive values is equivalent to inverting the terms “increase” and “decrease” in the algorithm.

QI2_{target} normally represents the required quality of service (e.g. a target BLER of 0.01 is usual for voice services, . . . ). For example, in a system such as UMTS, the required quality of service is set when a call is set up in terms of target BER or target BLER.

This algorithm thus serves to change target SIR on the basis of a certain quality indicator QI1 which is different from QI2. QI2 is selected as a quality indicator corresponding to the target quality of service as given while the call is being set up, and this indicator might not be very appropriate. For example, BLER is not a very good quality indicator for a low value of BLER_{target} since it is rather difficult to estimate. Under such circumstances, a more accurate indicator is selected for the indicator QI1, for example raw BER, or more generally a transmission quality indicator rather than a service quality indicator (such as BLER or BER in particular). This makes it possible to improve the performance of the outer loop algorithm and thus to improve the capacity of the network.

By way of example, when QI1 is raw BER and QI2 is BLER, then an algorithm is obtained based on the following two outer loops:

a first outer loop 1 which fixes target SIR by comparing raw BER with target raw BER (if raw BER is greater than target raw BER, then target SIR is increases, otherwise it is decreased); and

a second outer loop 2 which fixes target raw BER by comparing BLER with target BLER (if BLER is greater than target BLER, then target raw BER is decreased, otherwise it is increased).

This makes it possible to change target SIR on the basis of raw BER which is easier to estimate than BLER, while still using BLER in order to verify that the quality of service (expressed in terms of target BLER) is achieved.

By way of example, the algorithm can be written as follows:

if (raw_BER<raw_BER_{target}), then target SIR is decreased by δ1_{down}, else target SIR is increased by δ1ᵤₚ; and

if (BLER<BLER_{target}), then raw_BER_{target} is increased by δ2ᵤₚ, else raw_BER_{target} is decreased by δ2_{down};

where δ1ᵤₚ, δ1_{down}, δ2ᵤₚ, and δ2_{down} are positive.

Averaging is normally performed over a certain number of time periods in order to obtain an accurate estimate for a quality indicator. In such an algorithm, the averaging period for QI1 and QI2 can be different. For example, when QI2 is BLER the averaging period can be selected to be equal to an integer number of TTIs (large enough to obtain an accurate estimate for BLER). In addition, in such an algorithm, the execution period of a loop can be different from the averaging period. For example, estimated BLER can be calculated on the basis of 100*TTI while the loop can be executed once every TTI, once every two TTIs, etc. (in which case a moving window can be used for averaging).

In an aspect of the invention, in the preceding algorithm, the second outer loop algorithm is advantageously replaced by an algorithm such as the following:

each time an error is detected, QI1_{target} is decreased by δ2_{down}, else QI1_{target} is increased by δ2ᵤₚ.

In other words, or more generally, when the second quality indicator indicates an error rate, said target value for the first outer loop is adjusted each time an error is detected.

This serves essentially to conserve the advantages of the “sawtooth” algorithm such as, in particular, better reactivity in the presence of fast changes in transmission conditions, and less complexity. In other words, and contrary to the above-cited prior documents, the present invention makes it possible not only to avoid the drawback of the “sawtooth” algorithm, but also to conserve its advantages.

A detected error corresponds to a block being detected as erroneous when the quality indicator QI2 is BLER, to a data bit being detected as being erroneous when QI2 is BER, to a raw bit detected as being erroneous when QI2 is raw BER, etc. Errors can be detected in any conventional manner: for example erroneous blocks are conventionally detected by using a CRC associated with each block.

In addition, in order to reach the required quality of service QI2_{target}, δ2ᵤₚ, and δ2_{down} are preferably determined in such a manner that on average the second quality indicator QI2 reaches the second outer loop target value QI2_{target}. These parameters can thus satisfy a relationship of the following type:

δ2_{down}*QI2_{target}=d2ᵤₚ*(1−QI2_{target})

By way of example, when QI2 is raw BER and QI2 is BLER, the algorithm becomes:

if (raw_BER<raw_BER_{target}), target SIR is decreased by δ1_{down}, else target SIR is increased by δ1ᵤₚ; and

the received block is detected as being erroneous, raw_BER_{target} is decreased by δ2_{down}, else raw_BER_{target} is increased by δ2ᵤₚ;

preferably with:

δ2_{down}*BLER_{target}=δ2ᵤₚ*(1−BLER_{target})

It should be observed that in a system such as UMTS, blocks correspond to transport blocks obtained for one or more transport channels capable of being transported simultaneously over a single connection. In the general case where there can be a plurality of transport channels, the algorithm can be applied to one or more transport channels. When it is applied to a plurality of transport channels, the corresponding quality indicators can be averaged over the set of transport channels. When it is applied to a single transport channel, it is preferable to select the transport channel which requires the highest transmission power to reach its quality of service (so as to guarantee that if quality of service is reached on that transport channel, then it is certain to be reached on the other transport channels).

It should also be observed that in a system such as UMTS, several types of BER can be used, such as “transport channel BER” and “physical channel BER” as specified in the specification 3GPP TS 25.215, e.g. for the case where the algorithm is implemented in the RNC.

Furthermore, in another aspect of the present invention, the second outer loop algorithm is advantageously replaced by an algorithm such as the following:

if |QI1−QI1_{target}|<η:

if (Q12<QI2_{target}), then QI1_{target} is increased by δ2ᵤₚ,

else it is decreased by δ₂_{down};

else no action is performed;

where η>0 is a parameter of this algorithm.

In general, the idea is to avoid changing the target value for the first outer loop (QI1_{target}) until said first outer loop has converged (i.e. until QI1 is close enough to QI1_{target}). This makes the algorithm much more stable. Otherwise, there is a risk of QI1_{target} and thus also SIR_{target} being increased without being within reach, and consequently there is a risk of transmission power reaching values that are pointlessly high, thus wasting transmission power and degrading overall performance of the system.

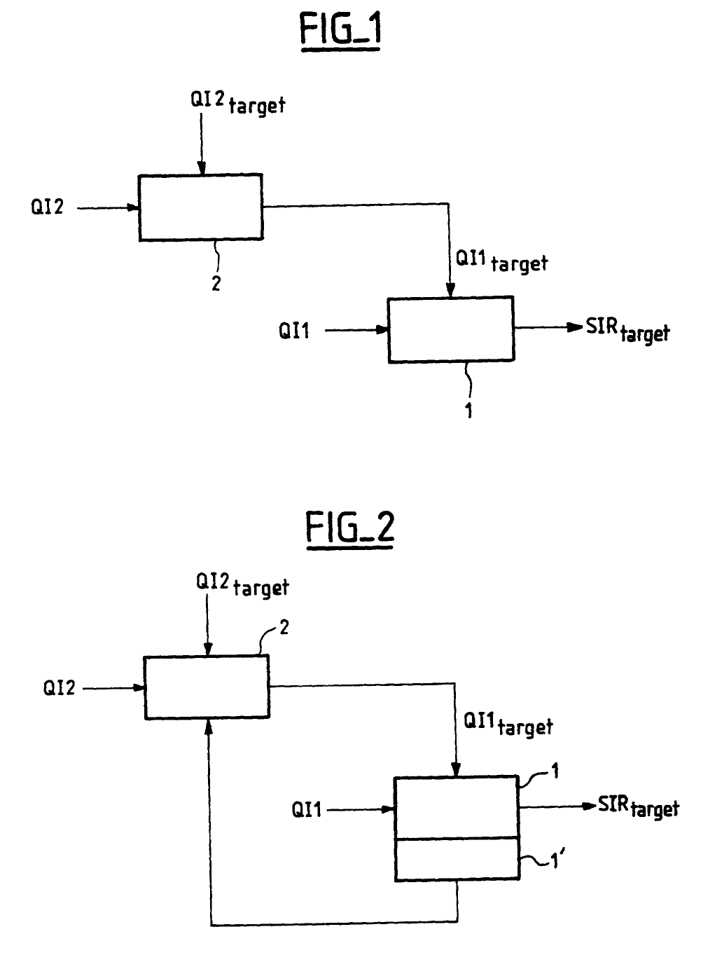

As shown in FIG. 2, the first outer loop then comprises, compared with FIG. 1, additional means referenced 1′ for ensuring that the target value of the first outer loop is adjusted only if this first loop has already converged.

It should be observed that this idea is applicable whatever the way in which the first and second outer loops are embodied and whatever the quality indicator selected for each of said loops. In particular, this idea is applicable to both of the above-described second outer loop algorithms.

Furthermore, another aspect of the present invention concerns initialization or how to determine the best initial value for the inner loop target value SIR_{target} and the first outer loop target value QI1_{target} (the target value of the second outer loop being fixed as a function of the required quality of service).

A problem arises on initialization (or when setting up a call) in that if these values are not well chosen, then that can have the consequence of increasing initial convergence time required for reaching “ideal” values for the target values (i.e. values that would enable quality of service to be achieved with minimum transmission power).

For example, if QI1_{target} is initialized on a value that is much greater than its ideal value, then SIR_{target} will significantly exceed its ideal value and the time required for convergence of the values QI1_{target} and SIR_{target} on their ideal values will be significantly increased. During this time, a large amount of transmission power will be wasted, and the capacity of the system as a whole will be significantly degraded.

To avoid such drawbacks, the present invention proposes several solutions.

In a first solution, at the beginning of a call, the outer power control loop is not activated for a certain length of time. During this period, quality is measured by means of the quality indicator QI1, and after this period, the outer power control loop is activated with QI1_{target} equal to the value of QI1 as measured in this way. The initial target value for SIR is fixed to be as close as possible to the ideal value for target SIR, e.g. by using the results of earlier measurements or the results of simulation. It is preferably fixed a little above the estimated ideal target value since convergence is faster when the initial value for target SIR is greater than the ideal value for target SIR.

In other words, in this first solution, the initial value of the target value for the first outer loop is obtained by measurements performed for a predetermined value of the inner loop target value. Specifically, said predetermined value for the inner loop target value is selected to be as close as possible to an ideal value.

In a second solution, the target value of the first outer loop QI1_{target} is fixed at the beginning of a call to a value which is as close as possible to its ideal value, possibly as estimated on the basis of the results of earlier simulations or measurements, and the preceding idea is also applied whereby the target value for the first outer loop (QI1_{target}) is changed only after the first outer loop has already converged, so that QI1_{target} is not modified until QI1 has already come close enough to QI1_{target}.

In other words, in this second solution, the initial value for the target value of the first outer loop is selected to be as close as possible to an ideal value, and the target value of the first outer loop is adjusted only once said first outer loop has converged.

Other solutions are also possible, with the common idea in these various solutions being that the initial values of SIR_{target} and of QI1_{target} should correspond approximately to the same level of transmission power, i.e. these values should be capable of being reached approximately simultaneously for the same transmission power (where “approximately” means that there is little likelihood in practice of managing to initialize SIR_{target} and QI1_{target} with values that are reached exactly simultaneously, because of the inaccuracies in estimating these two values). This ensures that the algorithm is stable during the initialization stage and prevents these two values from moving quickly away from their ideal values during such initialization.

It should also be observed that this idea is applicable regardless of the way in which the first and second outer loops are embodied and regardless of which quality indicator is selected for each of said loops.

The following solution of the invention can be used in any mobile radiocommunications system, and in particular in a CDMA system such as UMTS.

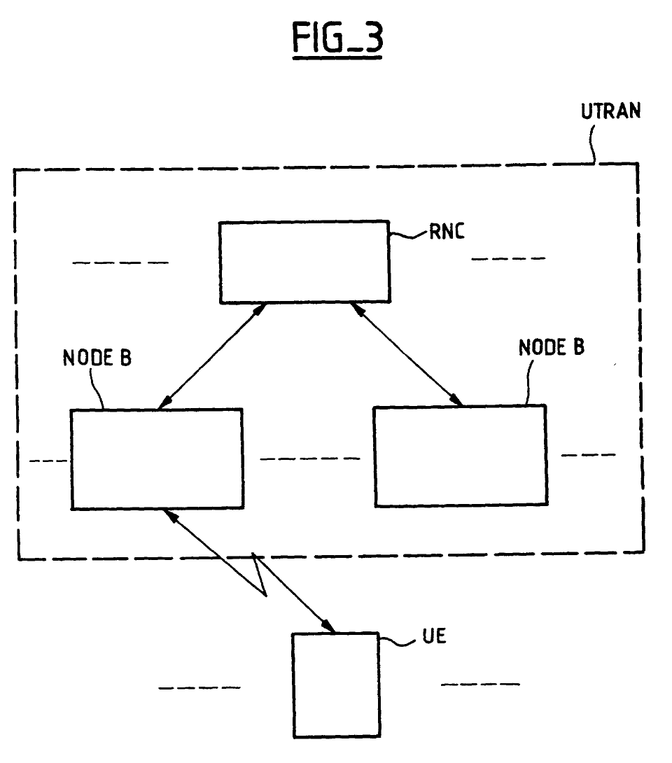

In general, as shown in FIG. 3, a mobile radiocommunications system comprises the following entities: mobile stations (also known as user equipment or UE in UMTS), base stations (referred to as “Node B” in UMTS), and base station controllers (referred to as “radio network controllers” (RNCs) in UMTS). The system made up of the Node Bs and the RNC is also referred to as a UMTS terrestrial radio access network (UTRAN).

In general, the outer power control loop is generally implemented in the receiver (UE in the down direction, for example), since it is more logical to estimate the quality required for this outer loop in a receiver. In addition, in a system such as UMTS, the RNC is in charge of network control and of the actions performed by a UE, while a Node B is mainly a transceiver. Thus, the outer power control loop in the up direction is generally implemented in the RNC. The outer power control loop in the down direction is implemented in the UE. The inner power control loop is implemented in part in the UE and in part in the node B; for example in the up direction, the node B compares the estimated SIR with the target SIR and sends a power control command to the UE, and the UE modifies the power it transmits as a function of the power control commands issued by the node B.

The present invention also provides:

a mobile station (in particular user equipment (UE) in a system such as UMTS);

network equipment for mobile radiocommunications (in particular a radio network controller (RNC) in a system such as UMTS, or indeed a base station such as a Node B in a system such as UMTS);

a mobile radiocommunications network; and

a mobile radiocommunications system;

each including means for implementing a method in accordance with the invention.

These various means can operate using any of the methods described above. Particular implementation thereof does not present any difficulty for the person skilled in the art, and such means do not need to be described herein in greater detail than in terms of their function.

1/ A method of adjusting the target value of an inner power control loop in a mobile radiocommunications system, in which method:
said inner loop target value is adjusted by a control loop referred to as a “first outer loop” operating on the basis of a quality indicator referred to as a “first quality indicator” and of a target value for said first quality indicator referred to as a “first outer loop target value”;
said first outer loop target value is adjusted by a control loop referred to as a “second outer loop” operating on the basis of a quality indicator referred to as a “second quality indicator” and of a target value for said second quality indicator referred to as a “second outer loop target value”; and
said second quality indicator gives an error rate and said first outer loop target value is adjusted each time an error is detected.

2/ A method according to claim 1, in which the information transmitted in said system is structured in blocks on the basis of which said second quality indicator is obtained, and said first outer loop target value is adjusted block by block.

3/ A method according to claim 1, in which the second outer loop adjusts the first outer loop target value by a first value or a second value depending on whether or not an error is detected.

4/ A method according to claim 3, in which said first and second values and the second outer loop target value are related in such a manner that on average the second quality indicator reaches the second outer loop target value.

5/ A method according to claim 1, in which said first quality indicator is a transmission quality indicator.

6/ A method according to claim 5, in which said first quality indicator is raw BER.

7/ A method according to claim 1, in which said second quality indicator is a service quality indicator.

8/ A method according to claim 7, in which said second quality indicator is BLER.

9/ A method of adjusting the target value of an inner power control loop in a mobile radiocommunications system, in which method:
said inner loop target value is adjusted by a control loop referred to as a “first outer loop” operating on the basis of a quality indicator referred to as a “first quality indicator” and of a target value for said first quality indicator referred to as a “first outer loop target value”;
said first outer loop target value is adjusted by a control loop referred to as a “second outer loop” operating on the basis of a quality indicator referred to as a “second quality indicator” and of a target value for said second quality indicator referred to as a “second outer loop target value”; and
said first outer loop target value is adjusted only once said first outer loop has already converged.

10/ A method of adjusting the target value of an inner power control loop in a mobile radiocommunications system, in which method:
said inner loop target value is adjusted by a control loop referred to as a “first outer loop” operating on the basis of a quality indicator referred to as a “first quality indicator” and of a target value for said first quality indicator referred to as a “first outer loop target value”;
said first outer loop target value is adjusted by a control loop referred to as a “second outer loop” operating on the basis of a quality indicator referred to as a “second quality indicator” and of a target value for said second quality indicator referred to as a “second outer loop target value”; and
initial values for said inner loop target value and said first outer loop target value are determined so as to be capable of being reached approximately simultaneously for transmission at the same power level.

11/ A method according to claim 10, in which said initial value for the first outer loop target value is obtained by measurements performed for a predetermined value of said inner loop target value.

12/ A method according to claim 11, in which said predetermined value for the inner loop target value is selected to be as close as possible to an ideal value.

13/ A method according to claim 10, in which said initial value for the first outer loop target value is selected to be as close as possible to an ideal value, and said first outer loop target value is adjusted only once said first outer loop has already converged.

14/ A mobile station including means for implementing the method according to claim 1.

15/ Mobile radiocommunications network equipment including means for implementing a method according to claim 1.

16/ A mobile radiocommunications system including means for implementing a method according to claim 1.
